(19) United States
(12) Patent Application Publication
(10) Pub. No.: US 2007/0036024 A1
(43) Pub. Date: Feb. 15, 2007

(54) Fluid blending and mixing system

(75) Inventors: Ronald W. Kubala, Green Bay, WI (US); Vladimir Chernin, Green Bay, WI (US); David R. Krause, De Pere, WI (US)

Correspondence Address: GAMBURD LAW GROUP LLC, 600 WEST JACKSON BLVD., SUITE 625, CHICAGO, IL, 60661, US

(73) Assignee: Cleaning Systems, Inc., DePere, WI (US)

(21) Appl. No.: 11/200,657

(22) Filed: Aug. 10, 2005

(51) Int. Cl. B01F 15/04

(52) U.S. Cl. 366/163.2

(57) ABSTRACT

A fluid mixing and blending system employs a fluid mixing passage having two or more discrete, individually controllable mixing elements located along the mixing passage. The use of a single mixing passage with multiple mixing elements, such as venturis, assures consistent and precise mixing, with a system which is economical to produce.

### BACKGROUND OF THE INVENTION

1. Field of the Invention

The present invention relates to a system for selectively blending and mixing fluids, such as cleaning fluid concentrates and a carrier fluid, such as water. The present system is ideally employed in a vehicle washing facility or other facility in which a variety of solutions must be blended and mixed in a relatively precise, yet cost effective manner.

2. Disclosure Information

Commercial cleaning establishments such as carwashes typically employ several cleaning solutions to economically treat various areas of a vehicle. For example, solutions used for cleaning the painted surfaces of a vehicle and wheel cleaning solutions usually have different concentrations, and even different base components. This arises from the fact that road grime clinging to a painted surface and disc brake dust will not necessarily respond optimally to the same cleaning solution.

Designers of commercial cleaning solution blending and mixing systems have employed a variety of configurations to provide solutions for carwashes. U.S. Pat. No. 5,439,020 discloses a detergent mixing apparatus and method in which reservoirs of various cleaning solution concentrates are manifolded together and drawn through a single eductor. The mixing ratios produced by the system of the '020 patent would be difficult to adjust because of cross-talk or interference between the competing concentrate fluid flows. U.S. Pat. No. 5,678,593 discloses a detergent mixing apparatus in which multiple eductors are used in parallel to blend washing solutions. Because each eductor is driven by a separate flow of carrier fluid, the mixing of the final solution must be carefully controlled to avoid stratification of the finished solution. Also, each of the individual carrier fluid flows must be carefully controlled to achieve and maintain a precise mixing ratio. This may necessitate the use of more expensive flow control valves. In addition, the fluids are not mixed completely until they have been ejected into a separate holding tank.

A system according to the present invention solves problems associated with prior blending and mixing systems by allowing precise, easily adjustable and controllable feeding and mixing of cleaning solution concentrates into a single carrier fluid stream.

### SUMMARY OF THE INVENTION

According to one aspect of the present invention, a fluid blending and mixing system includes a carrier fluid inlet, a mixing passage connected with said fluid inlet, with said mixing passage having a central axis, and a plurality of discrete, individually controllable mixers located along the central axis of said mixing passage such that a plurality of concentrate fluids may be blended and mixed into a carrier fluid flowing through said mixing passage. Each of the individually controllable mixers is fed with a different concentrate fluid and each includes a venturi having an orifice-controlled concentrate port. An upstream venturi blends and mixes a first concentrate fluid with the carrier fluid. At least one downstream venturi blends and mixes a second concentrate fluid with the blended and mixed fluid flowing from the first venturi.

The ratio of the throat diameter of the downstream venturi to the throat diameter of the upstream venturi is generally in the range of 1.0 to 1.9, and more particularly in the range of 1.2 to 1.9.

According to another aspect of the present invention, each of said individually controllable mixers may include a venturi having a concentrate port controlled by an electronic controller, such as a microprocessor, microcontroller, other microprocessor controller or a programmable logic controller (PLC) powering an electrically operated valve. As an alternative, the electronic controller may control a mixing valve through which concentrate is being drawn by a pump.

According to another aspect of the present invention, a fluid blending and mixing system includes a dissolution tank for dissolving powered chemicals and for providing the resulting liquid to at least one controllable mixer. The dissolution tank includes at least a water inlet valve and a mechanical mixer, with both said inlet valve and said mechanical mixer preferably being controlled by a microprocessor controller.

A system according to the present invention transfers the blended and mixed fluid flowing from the mixing passage to either a receiving tank or to the inlet of a distribution pump which delivers the finished fluid to one or more points of usage.

According to another aspect of the present invention, the mixing passage may include at least a manifold connected with the inlet of a pump, and with the individually controllable mixers including more than one electrically operated valve, and with the pump and valves being controlled by a microprocessor controller.

According to another aspect of the present invention, a method for blending and mixing a plurality of concentrate fluids into a carrier fluid, includes at least the steps of introducing a carrier fluid into a mixing passage, followed by blending a first concentrate fluid into the flowing carrier fluid by providing the first concentrate fluid to an upstream mixing venturi located along said mixing passage. Finally, the method includes the step of blending a second concentrate fluid into the blended and mixed fluid flowing from the upsteam venturi by providing the second concentrate fluid to a downstream venturi which receives the fluid flowing from the upstream venturi, with the downstream venturi having a throat which is at least as large as the throat of the upstream venturi.

It is an advantage of a blending and mixing system according to the present invention that more than one concentrate fluid may be progressively blended and mixed into a carrier fluid flowing through a single mixing passage. This simplifies the architecture of a mixing system, while providing maximum flexibility to control the flow ratios of the concentrates being added.

It is a further advantage of a system according to the present invention that the ratios of the concentrates being added to the carrier fluid may be easily adjusted to accommodate changes in the condition of vehicles. For example, for extremely dirty vehicles, the concentration of washing agents may be increased, while preserving the possibility of greater economy in terms of less usage of chemicals and rinse water when vehicles are less heavily soiled.

These and additional embodiments are discussed in greater detail below. Numerous other advantages as well as features and objects of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings and examples which form a portion of the specification, wherein like reference numerals are used to identify identical components in the various diagrams, in which:

Figure (or FIG.) 1 is a logarithmic graphical diagram showing the empirical relationship between pressure ratio and venturi throat diameter ratio for a flow system including upstream and downstream venturis or eductors.

Figure (or FIG.) 2 is a schematic representation of an exemplary first embodiment of a fluid blending and mixing system according to the present invention.

Figure (or FIG.) 3 is a schematic representation of an exemplary second embodiment of a fluid blending and mixing system according to the present invention including electronically controlled valves controlling the flow of concentrate through multiple fluid mixers.

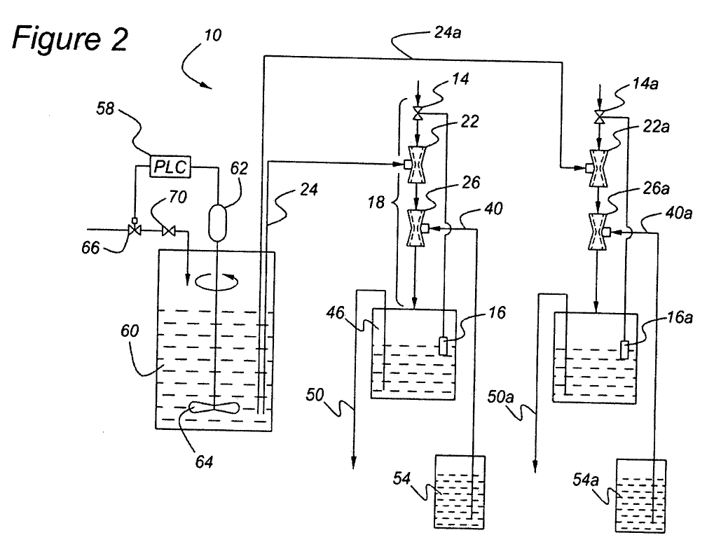

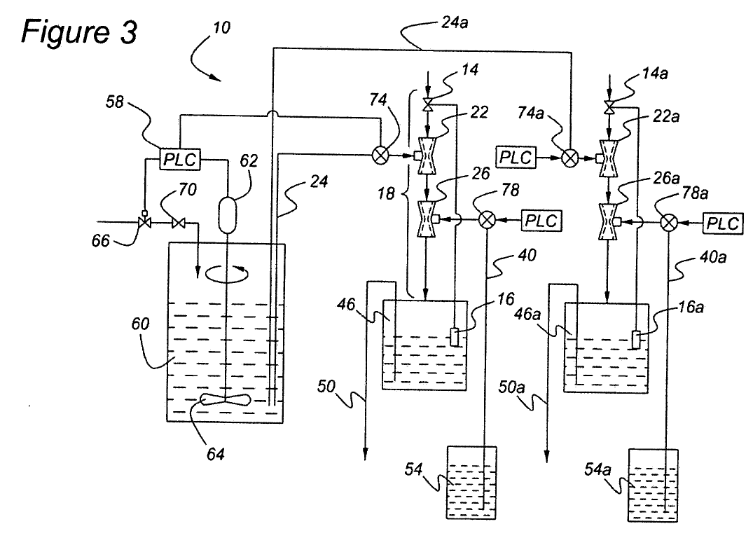

Figure (or FIG.) 4 is a schematic representation of an exemplary third embodiment of a fluid blending and mixing system according to the present invention and is similar to FIGS. 2 and 3, but shows a fluid distribution pump connected to the outlet of the mixing passage.

Figure (or FIG.) 5 is a schematic representation of an exemplary fourth embodiment of the present invention having a controller which operates all of the fluid metering functions.

Figure (or FIG.) 6 is a perspective view illustrating an exemplary hardware configuration for the exemplary systems of FIGS. 2 and 3.

### DETAILED DESCRIPTION OF THE EXEMPLARY EMBODIMENTS

The present system uses two venturis located in series to mix and blend fluids. In accordance with the exemplary embodiments of the present invention, the ratio of the throat diameter, D2, of the downstream venturi, to the throat diameter, D1, of the upstream venturi may be calculated by using the following formula:
D2/D1=(P1/P2)^{1/n}(C1E1/C2E2)^{2/n} (1)
Where:
P1, P2—pressure drop through the upstream and downstream venturis, respectively;
C1, C2—discharge coefficient for the upstream and downstream venturis, respectively; and
E1, E2—parameter for upstream and downstream venturis, respectively.
   In formula (1) the power coefficient, n, is preferably in the range of 2 to 8. Parameter E (forming E1 or E2) is calculated by using the following formula:
   E=[1/(1−(D/D₁)⁴)]^{1/2} (2)
   Where:
D₁—diameter of inlet for each venturi; and
D—throat diameter for each venturi (D1 for the upstream venturi and D2 the downstream venturi).

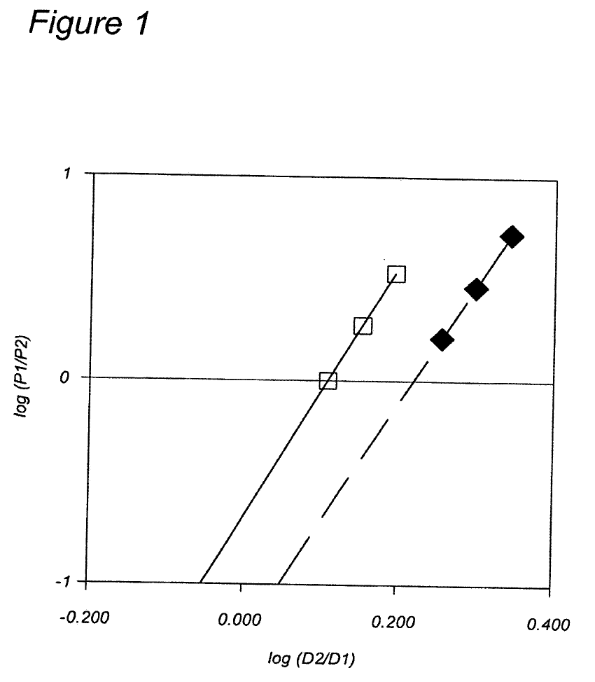

FIG. 1 is a graph illustrating the empirically determined linear logarithmic relationship between pressure drop through the upstream and downstream venturis and the ratio of throat diameter D2 of the downstream venturi to throat diameter D1 of the upstream venturi, in accordance with the exemplary embodiments of the present invention. In a first experimental set the throat diameter of the upstream venturi was 5/64 inch and in the second experimental set the throat diameter of the upstream venturi was 7/64 inch.

In accordance with the exemplary embodiments, the empirical relationships of FIG. 1, and formulas (1) and (2) of the present invention, throat diameters D1 and D2 may be selected to provide desired mixing levels while concomitantly preserving appropriate fluid flow and avoiding the creation of positive pressures within the various venturis.

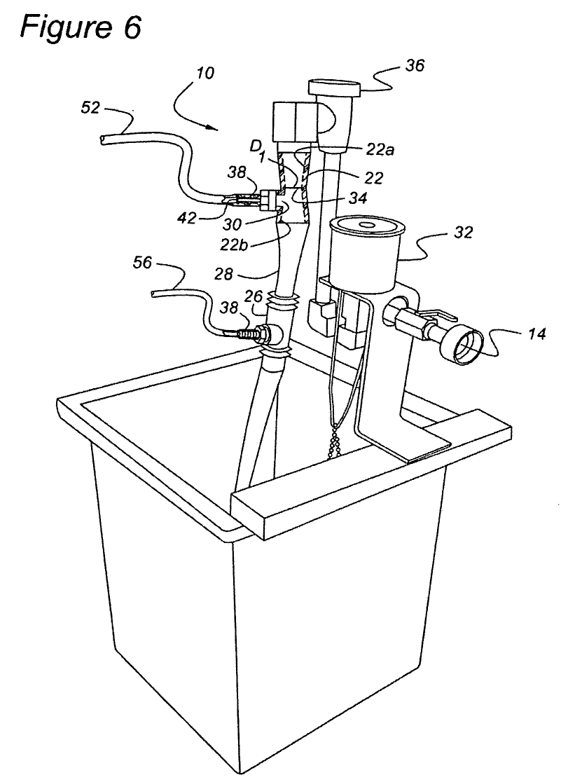

As shown in FIG. 2, exemplary fluid blending and mixing system 10 admits a carrier fluid, such as water, through inlet valve 14, which is controlled by sensor 16. Sensor 16 may comprise either a float or an electronic sensor, or yet another type of sensor known to those skilled in the art and suggested by this disclosure. Inlet valve 14 is connected with mixing passage 18, which collectively embraces a number of discrete, individually controllable operating elements. The first operating element is upstream mixer 22, which in a first embodiment, is a converging/diverging nozzle, sometimes termed an eductor or venturi. Upstream mixer 22, which is shown in greater detail in FIG. 6, has converging section 22a, diverging section 22b, and a throat, 34, having a diameter D1. A downstream mixer, 26, has a throat (not shown) having a diameter D2.

Flow through upstream mixer 22 is controlled by at least two factors. The first of these is the size of bore 42 extending through connector 38 (FIG. 6), which couples mixer 22 to a reservoir of liquid being drawn into mixer 22 through hose 52 for blending with carrier fluid flowing through mixing passage 18. The second factor affecting flow through mixer 22 is the ratio of the throat diameter of downstream mixer 26 to the throat diameter of mixer 22. The present inventors have determined that a system according to the present invention will operate satisfactorily with known vehicle washing concentrates if the ratio D2/D1 is substantially in the range of 1.0 to 1.9, and more specifically, substantially in the range of 1.2 to 1.9.

Returning to FIG. 2, it is seen that upstream mixer 22 draws fluid from dissolution tank 60 through line 24. This fluid is introduced into the carrier fluid flowing through mixing passage 18. Similarly, downstream mixer 26 draws fluid from concentrate reservoir 54 and introduces the concentrate into the combined fluid flowing from upstream mixer 22. In this manner, the mixing action is progressive and assures consistent mixing and blending.

After transiting mixing passage 18, the mixed and blended fluid is discharged into receiving or dilution tank 46. Then the fluid is discharged through outlet line 50 to one or more points of use.

The present system may be employed to make up any number of different diluted solutions, and the portion of system 10 having mixers 22a and 26a and the illustrated associated hardware are an example of this flexibility.

Dissolution tank 60 carries a common blending stock for the exemplary system illustrated in FIG. 2. Operation of tank 60 is handled by programmable logic controller (PLC) 58, which may comprise any one of a variety of microprocessors or other controllers known to those skilled in the art and suggested by this disclosure. PLC 58 controls inlet valve 66, which admits water into tank 60. The actual flow rate is controlled by flow control valve 70. PLC 58 also controls mechanical mixer motor 62 which has agitator paddle 64 attached to its lowest extremity.

Returning to FIG. 6, mixers 22 and 26 are shown as being in fluid communication via connector line 28. Water is supplied to mixer 22 by float controlled valve 32, which sends the water through vacuum breaker 36. Hose 56 is used to draw concentrate into mixer 26, which is equipped with a connector 38 having a suitably sized bore 42 (not shown) for metering concentrate into mixer 26.

FIG. 3 is similar to FIG. 2, but in the exemplary embodiment of FIG. 3, the flow from dissolution tank 60 into mixer 22 is controlled by PLC 58 by means of electrically operated valve 74. Valve 74 may be either a simple on-off solenoid valve, or a more sophisticated pulse width modulated valve, or yet other types of valves suggested by this disclosure. Valves 78, and 74a and 78a, which are also controlled by PLC 58, also perform the function of metering blending fluids, such as concentrates, into the dilution tanks.

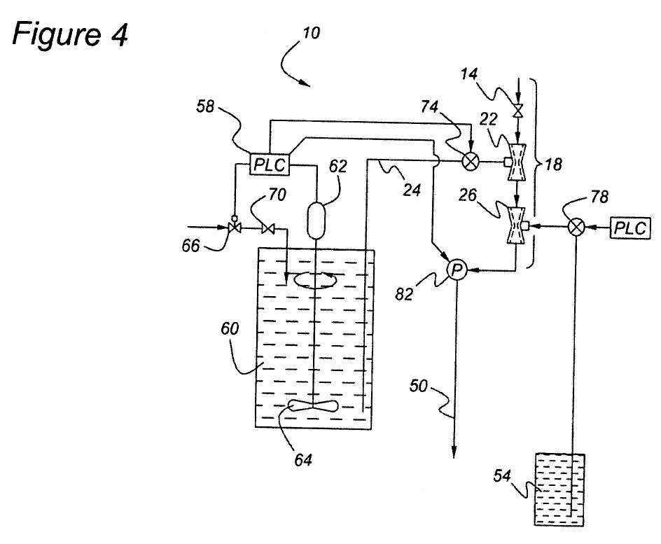

The exemplary embodiment of FIG. 4 is particularly useful when it is necessary or desirable either to locate the dilution tank remotely from the blending and mixing apparatus, or when the system is operated on a “blend on demand” basis. Accordingly, pump 82, which has an inlet connected to the outlet of mixing passage 18, immediately distributes the diluted washing solution. Another advantage of the embodiment of FIG. 4 is that complete mixing has occurred prior to the flow of the blended fluid to pump 82, eliminating any need for any holding tank for the resulting blended fluid, in marked contrast with the prior art.

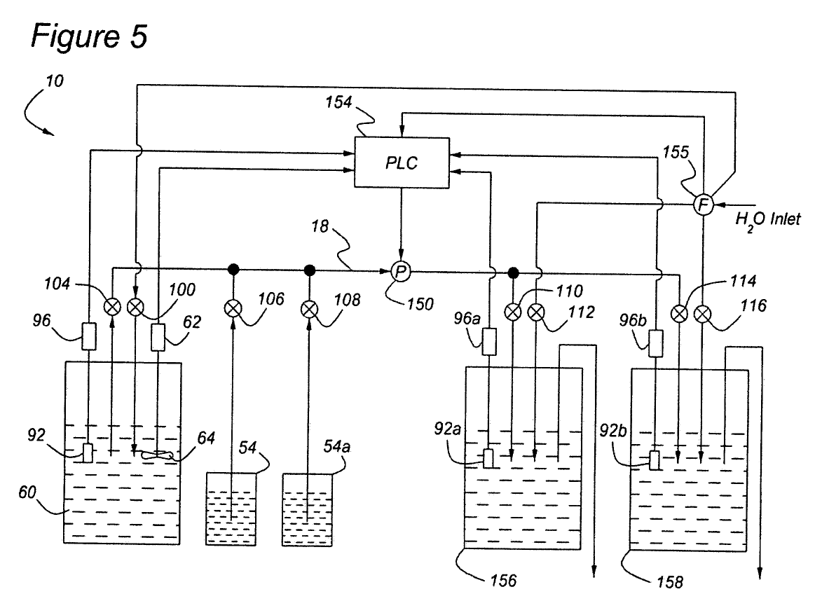

In the exemplary embodiment of FIG. 5, mixing passage 18 extends from pump 150 to dissolution tank 60. Pump 150 withdraws blending liquids from tanks 60, 54, and 54a through valves 104, 106, and 108, respectively. Each of these valves, and for that matter, each of the other illustrated valves, is controlled by PLC 154.

The agitation action occurring inherently within pump 150 helps to assure uniform mixing of the blended fluid. Downstream from pump 150, the blended fluid is retained in tanks 156 and 158. Water for blending and for making up the solution within dissolution tank 60 is controlled by valves 100, 112, and 116. Precise control of the water flow is enabled by flow meter 155, which is connected with PLC 154.

The system of FIG. 5 is advantageous because it does not require any metering orifices or venturis, and no float valves. Because all blending is controlled electronically, the concentrations of the various blending agents may be easily controlled to account for varying weather conditions, such as ambient temperature and pressure, varying water supply pressures, and other variable conditions.

Although the present invention has been described in connection with particular embodiments thereof, it is to be understood that various modifications, alterations, and adaptations may be made by those skilled in the art without departing from the spirit and scope of the invention set forth in the following claims. It is to be understood that no limitation with respect to the specific methods and apparatus illustrated herein is intended or should be inferred. It is, of course, intended to cover by the appended claims all such modifications as fall within the scope of the claims.

We claim:

1. A fluid blending and mixing system, comprising:
a carrier fluid inlet;
a mixing passage connected with said fluid inlet, with said mixing passage having a central axis; and
a plurality of discrete, individually controllable mixers located along said central axis of said mixing passage such that a plurality of concentrate fluids may be blended and mixed into a carrier fluid flowing through said mixing passage.

2. A fluid blending and mixing system according to claim 1, wherein said individually controllable mixers comprises a plurality of venturis, with each having an orifice-controlled concentrate port.

3. A fluid blending and mixing system according to claim 2, wherein said plurality of venturis comprise an upstream venturi for blending and mixing a first concentrate fluid with said carrier fluid, and at least one downstream venturi for blending and mixing a second concentrate fluid with the blended and mixed fluid flowing from the first venturi.

4. A fluid blending and mixing system according to claim 3, wherein the ratio of the throat diameter of said at least one downstream venturi to the throat diameter of the upstream venturi is substantially in the range of 1.0 to 1.9.

5. A fluid blending and mixing system according to claim 3, wherein the ratio of the throat diameter of said at least one downstream venturi to the throat diameter of the upstream venturi is substantially in the range of 1.2 to 1.9.

6. A fluid blending and mixing system according to claim 1, wherein each of said individually controllable mixers is furnished with a different concentrate fluid.

7. A fluid blending and mixing system according to claim 1, wherein each of said individually controllable mixers comprises a venturi having a concentrate port controlled by an electronic controller.

8. A fluid blending and mixing system according to claim 7, wherein at least one of said concentrate ports is fed with concentrate fluid flowing through an electrically operated valve operatively connected with a microprocessor, a controller or a programmable logic controller.

9. A fluid blending and mixing system according to claim 1, wherein each of said individually controllable mixers comprises a mixing valve controlled by an electronic controller.

10. A fluid blending and mixing system according to claim 1, further comprising a dissolution tank for dissolving powered chemicals and for providing the resulting liquid to at least one of said controllable mixers.

11. A fluid blending and mixing system according to claim 10, in which said dissolution tank comprises a water inlet valve and a mechanical mixer, with both said inlet valve and said mixer being controlled by a microprocessor, a controller or a programmable logic controller.

12. A fluid blending and mixing system according to claim 1, further comprising a receiving tank for storing blended and mixed fluid flowing from said mixing passage.

13. A fluid blending and mixing system according to claim 1, further comprising a pump, having an inlet connected to an outlet of said mixing passage, for receiving fluid flowing from the carrier passage and for distributing the blended and mixed fluid to a point of usage.

14. A fluid blending and mixing system according to claim 1, wherein said mixing passage comprises a manifold connected with a pump inlet, with said individually controllable mixers comprising a plurality of electrically operated valves, with said pump and said valves being controlled by a microprocessor, a controller or a programmable logic controller

15. A fluid blending and mixing system, comprising:
a carrier fluid inlet;
a mixing passage connected with said fluid inlet, with said mixing passage having a central axis; and
a plurality of discrete, individually controllable mixing venturis located along said central axis of said mixing passage and separated axially from one another such that a plurality of concentrate fluids may be progressively blended and mixed into a carrier fluid flowing through said mixing passage.

16. A fluid blending and mixing system according to claim 15, wherein the plurality of discrete, individually controllable mixing venturis further comprise an upstream venturi and at least one downstream venturi, and wherein the ratio of the throat diameter of said at least one downstream venturi to the throat diameter of the upstream venturi is substantially in the range of 1.2 to 1.9.

17. A fluid blending and mixing system according to claim 15, wherein each of said discrete, individually controllable mixing venturis has a concentrate port controlled by an electronic controller.

18. A fluid blending and mixing system according to claim 17, wherein at least one of said concentrate ports is fed with concentrate fluid flowing through an electrically operated valve operatively connected with a microprocessor, a controller or a programmable logic controller.

19. A fluid blending and mixing system according to claim 15, further comprising a pump, having an inlet connected to an outlet of said mixing passage, for receiving fluid flowing from the mixing passage and for distributing the blended and mixed fluid to a point of usage.

20. A method for blending and mixing a plurality of concentrate fluids into a carrier fluid, comprising the steps of:
introducing a carrier fluid into a mixing passage;
blending a first concentrate fluid into the flowing carrier fluid by providing the first concentrate fluid to an upstream mixing venturi located along said mixing passage; and
blending a second concentrate fluid into the blended and mixed fluid flowing from the upstream venturi by providing the second concentrate fluid to a downstream venturi which receives the fluid flowing from the upstream venturi, with the downstream venturi having a throat which is at least as large as the throat of the upstream venturi.
